(19) United States
(12) Patent Application Publication
(10) Pub. No.: US 2004/0257206 A1
(43) Pub. Date: Dec. 23, 2004

(54) Hermetically sealed communication device

(76) Inventors: Bruce Arthur Kivisto, Cokato, MN (US); William Bradley Zobel, Dassel, MN (US); David Augustin Loegering II, Lester Prairie, MN (US); Mark Peter Stoner, Dassel, MN (US)

Correspondence Address: Devan V. Padmanabhan, Esq., DORSEY & WHITNEY LLP, Suite 1500, 50 South Sixth Street, Minneapolis, MN, 55402-1498, US

(21) Appl. No.: 10/876,264

(22) Filed: Jun. 24, 2004

Related U.S. Application Data
(63) Continuation of application No. 10/198,943, filed on Jul. 19, 2002, now abandoned.
Application No. 10/198,943 is a continuation of application No. 09/609,503, filed on Jul. 3, 2000, now abandoned.
(60) Provisional application No. 60/157,482, filed on Oct. 4, 1999.
(60) Provisional application No. 60/142,142, filed on Jul. 2, 1999.

(51) Int. Cl. G08B 3/00

(52) U.S. Cl. 340/384.1

(57) ABSTRACT

The present invention includes improved medical communication devices, such as nurse call cords, pillow speakers, and the like, that can be used in an oxygenated environment and that can withstand the sterilization and cleaning procedures commonly used in health care institutions. One embodiment of the present invention comprises a hermetically sealed housing and a switch. The switch is located within the hermetically sealed housing and is capable of converting an electrical input into an electrical signal. The present invention may further include a cable that communicates electrical signals to and from the communication.

Another embodiment of the present invention comprises a hermetically sealed housing and a sound generator. The sound generator is located within the hermetically sealed housing and is capable of converting an electrical input into an audible sound. The present invention may also include a switch located within the hermetically sealed housing. This switch may receive a command input from a patient and relay the command to a device under control. The present invention may further include a cable that communicates electrical signals to and from the sound generator.

Another aspect of the present invention is a method of making a medical communication device, one embodiment of which comprises providing a electronic communication component, such as a sound generator or a switch, attaching an electrical cable to the electronic communication component, and hermetically sealing the electronic communication component.

### RELATED APPLICATIONS

This application is a continuation of U.S. application Ser. No. 10/198,943, filed on Jul. 19, 2002, which is a continuation of U.S. application Ser. No. 09/609,503, filed on Jul. 3, 2000, now abandoned, which claims priority from Provisional Application Ser. No. 60/157,482, filed Oct. 4, 1999 and Provisional Application Ser. No. 60/142,142, filed Jul. 2, 1999.

### TECHNICAL FIELD

This invention generally relates to communication devices. More particularly, the invention relates to hermetically sealed communication devices, such as nurse call devices, pillow speakers, and the like, designed for use by the health care industry.

### BACKGROUND

Many health care institutions assign several patients to each nurse. These institutions frequently allow their patients to request nursing attention using a nurse call cord. Some call cords are connected to a two-way communication system that connects the patient's room to a central station. A nurse at the central station uses the communication system to determine the patient's needs and to dispatch the proper care-giver. Other call cords illuminate a light located outside the patient's room. This light alerts passing nurses that the patient needs attention. Nurse call cords are desirable because they allow health care institutions to use fewer nurses without sacrificing patient care.

Conventional nurse call cords have several serious deficiencies. For example, many current systems cannot be used in oxygen rich environments because of the risk that an electrical discharge or spark may cause a fire or an explosion. In addition, current systems cannot withstand the vigorous cleaning and sterilization procedures commonly used in health care institutions because moisture may enter the switch and cause electrical malfunction.

One partial solution to these problems is a call cord that produces an air pulse signal. These devices, however, are complex and expensive because they require an additional apparatus to convert the air pulse signal into an electrical signal. This converter must be located at a remote location, outside the hazardous area and away from the patient, and connected to the call cord by an air hose. These devices are also complex and expensive because they utilize many moving parts, some of which must be located outside the hazardous area and away from the patient.

Another problem with conventional nurse call systems is that the sound from the two-way communication system can disturb other patients. Because sleeping schedules vary greatly, health care institutions need an apparatus that will allow their patients to communicate with their nurses without disturbing others. One common solution to this problems utilizes “pillow speakers.” A pillow speaker is a small speaker that is physically located near each patient's head, and may be integrated into the patient's bed or may be an independent module. Some pillow speakers also provide television sound and have a plurality of switches that allow the bedridden patients to control various room functions, such as toggling the television on and off, changing the channel of the television, and turning the room lights on and off.

Like nurse call cords, one problem with conventional pillow speakers is that they cannot withstand the cleaning and sterilization methods commonly used in health care institutions because the moisture involved may cause an electrical malfunction. Health care institutions also cannot use conventional designs in oxygen rich environments because a discharge (“spark”) from the speaker's electrical components might ignite a fire or even cause an explosion. Thus, there is a need for a pillow speaker design that health care institutions can use oxygenated environments and that can withstand their sterilization and cleaning procedures.

Clearly, there is a need for simple, inexpensive, and reliable medical communication devices that health care institutions can use in oxygenated environments and that can withstand the sterilization and cleaning procedures used in the health care industry.

### SUMMARY

The present invention provides an improved medical communication device, such as nurse call cords, pillow speakers, and the like, that can be used in an oxygenated environment and that can withstand the sterilization and cleaning procedures used in health care institutions. One embodiment of this medical communication device comprises a hermetically sealed housing, and an electronic communication component located within the hermetically sealed housing. The switch in this embodiment is capable of communicating at least one electrical signal in response to an input from a patient.

One aspect of the present invention is a nurse call cord, one embodiment of which comprises a hermetically sealed housing and a switch located within the hermetically sealed housing. The switch is capable of communicating an electrical signal in response to an input from a patient. Some nurse call devices include a cable that communicates the electrical signal to and from the nurse call cord.

The present invention also includes a method of making a nurse call device that is suitable for use in an oxygen rich environment. The method may comprise the steps of providing a switch, attaching an electrical cable to the switch, and hermetically sealing the switch. The switch may be hermetically sealed by over-molding a polymeric housing around the switch.

In addition, the present invention provides an improved pillow speaker design that can be used in an oxygenated environment and that can withstand the sterilization and cleaning procedures used in health care institutions. One pillow speaker embodiment comprises a hermetically sealed housing and a sound generator located within the hermetically sealed housing. The sound generator is capable of converting an input into an audible sound. The sound generator may be a piezoelectric device and may be sterilized using conventional methods. Some pillow speaker embodiments may also comprise at least one switch located within the hermetically sealed housing that is capable of receiving an input command from a patient and communicating that command to a device under control. This switch may be part of a membrane switch assembly. The present invention may further comprise a control device and a cable that communicates electrical signals to and from the pillow speaker.

The present invention also includes a method of making a pillow speaker that is suitable for use in an oxygen rich environment. The method may comprise the steps of providing a housing, attaching a sound generator to the housing, attaching an electrical cable to the sound generator, and hermetically sealing the housing and the sound generator. Some embodiments may further comprise the steps of attaching a switch to the housing and hermetically sealing the switch.

One feature and advantage of the present invention is that it provides a simple, inexpensive medical communication device that health care institutions can use in an oxygen rich environment and that can withstand the sterilization and cleaning methods commonly used by hospitals. Some embodiments also eliminate the need for additional equipment to convert electrical signals into air pulses. These and other features, aspects, and advantages will become better understood with reference to the following description, appended claims, and accompanying drawings.

### BRIEF DESCRIPTION OF THE DRAWINGS

FIG. 1 is an isometric front view of a pillow speaker embodiment.

FIG. 2 is a circuit diagram of a membrane switch assembly.

FIG. 3 is a circuit diagram for a configurable input/output port.

FIG. 4 is a front view of a nurse call cord embodiment.

FIG. 5 is a diagram for a circuit suitable for use in a nurse call cord.

FIG. 6 is a diagram of one circuit embodiment for a nurse call cord.

FIG. 7 is a truth table for the internal switch in FIG. 6.

### DETAILED DESCRIPTION

I. First Embodiment

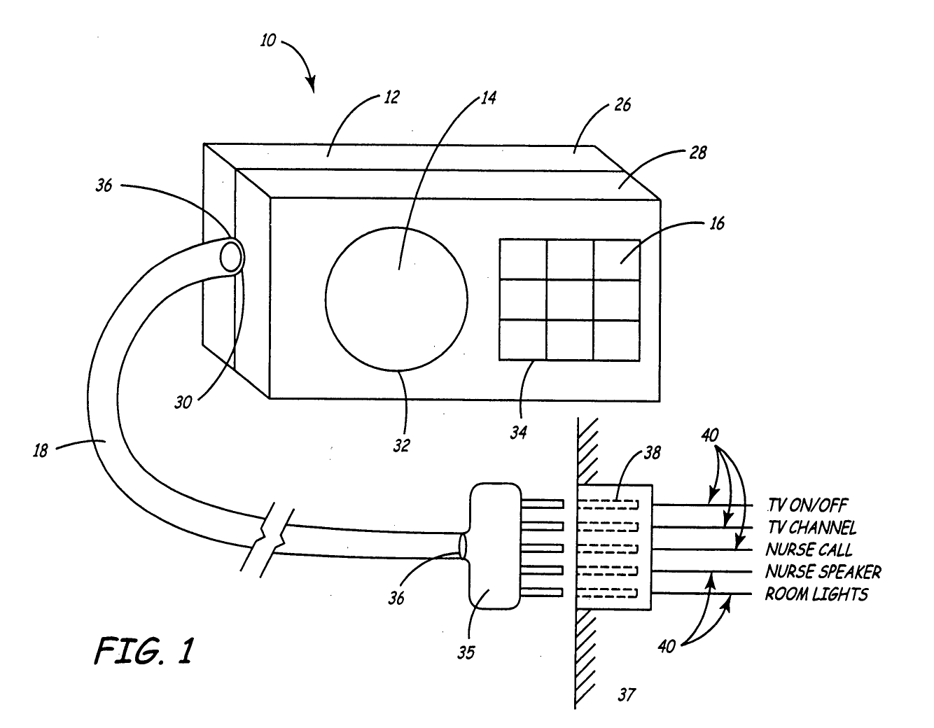

FIG. 1 is an isometric front view of a hermetically sealed pillow speaker embodiment 10. This pillow speaker embodiment 10 comprises a housing 12, a sound generator 14, a plurality of switches 16 and a flexible cable 18. The housing 12 may include a cable opening 30, a generally round opening 32, and a generally rectangular opening 34. The cable 18 has a first connector 35 and two seals 36. FIG. 1 also shows a wall section 37 that includes a second connector 38 capable of mating with the first connector 35 and an electrical wiring network 40. This network of electrical wires 40 may connect the second connector 38 to various equipment and signaling devices (not shown).

In some embodiments, the housing 12 is constructed from two sections 26, 28 that are hermetically sealed together. That is, the housing 12 should be constructed in such a way that liquids and gasses, particularly oxygen and water vapor, cannot enter into the interior of the pillow speaker 10 in concentrations sufficient to cause electrical malfunction, fire, or explosion hazards. However, one piece and multi-section housings 12 are also within the scope of this invention. The housing 12 may be constructed of any material that is relatively impermeable to liquids and gasses. It is desirable, however, that the housing material be relatively lightweight and corrosion resistant. Examples of appropriate materials include, without being limited to: aluminum, stainless steel, acrylonitrile butadiene-styrene (“ABS”), polytetrafluoroethylene (“PTFE”), polystyrene, polyethylene, and polyester.

The method chosen for hermetically sealing the housing 12 should be compatible with the chosen material and with standard cleaning and sterilization methods. Some embodiments of the present invention hermetically seal the housing 12 by placing O-rings between the two halves of the housing 12. This method is desirable because it allows for easy manufacture and because it will allow for repeated opening/resealing of the housing 12. Other appropriate methods for hermetically sealing the housing include, without being limited to, the use of adhesives, chemical welding, ultrasonic welding, gaskets, and sealants.

The cable 18 carries electrical signals between the first connector 22, the sound generator 14, and the plurality of switches 16. One end of the cable 18 enters the housing 12 through the cable opening 30 and terminates, inside the housing 12, at the sound generator 14 and the plurality of switches 16. The other end of the cable 18 is soldered to the first connector 22. A first seal 36 is placed in the cable opening 30 between the cable 18 and the housing 12. A second seal 36 is placed between in the opening between the cable 18 and the first connector 22. This allows the resulting housing/seal/cable and connector/seal/cable interfaces to resist entry by liquids and gasses. In some embodiments, the entire cable/seal/connector assembly may be further molded over by a flame proof plastic, such as ABS or polyvinyl chloride (“PVC”), or a thermoplastic rubber.

The first and second seals 36 can be any devices capable of preventing liquids or gasses from entering the housing 12 or the first connector 22. However, it is desirable that the seals 36 be resistant to most chemical cleaning and sterilization methods. Appropriate seals 36 include, without being limited to, an O-ring or a silicon sealant.

The sound generator 14 can be any device capable of converting an electrical signal into an audible sound. In one embodiment, the sound generator 14 is a hermetically sealed, piezoelectric device that is connected to the cable 18 and secured within the opening 32 by an appropriate adhesive, such as epoxy. The piezoelectric device of this embodiment is desirable as a sound generator because it can withstand the cleaning and sterilization methods commonly used in hospitals and because it is relatively durable. In another embodiment, the sound generator 14 is a Mylar-cone speaker that is sealed against the inside of the housing 12 by a relatively soft gasket or similar sealing device (not shown). Other sound generators capable of being cleaned and sterilized are also within the scope of this invention.

The switches 16 are optional devices that may convert user inputs into electrical signals. These electrical signals can be used in a variety of ways, such as toggling a television on or off, changing television channels, raising or lowering a hospital bed, adjusting the room's temperature, or calling a nurse. In one embodiment, the plurality of switches 16 are formed into a membrane switch assembly that is bonded to the opening 34 by a suitable waterproof adhesive. The membrane switch assembly in this embodiment is desirable because all of the switches 16 are integrated into a device that isolates the pillow speaker's electronic equipment from liquids and gasses. This feature allows the switches 16 to be used in oxygen rich environments and satisfies Underwriters' Laboratories (“UL”) requirements for hospital signaling and nurse call equipment and for use in hazardous locations. Other liquid and gas resistant switches 16, such as a “pushbutton” switch covered by a flexible membrane, are also within the scope of the present invention.

In operation, a nurse will first couple the first connector 22 to the second connector 38. This allows the cable 18 to carry electrical signals between the sound generator 14, the switches 16, and the electrical network 40. One of these electrical signals may represent the audio portion of a television signal or a question from a nurse located at a central nursing station. The sound generator 14 converts this electrical signal into an audible sound. Other electrical signals may be generated by the switches 16 in response to a user input. These electrical signals can be used control various functions, including toggling a television on or off, changing the channel on a television, operating a video cassette recorder (“VCR”), adjusting a hospital bed, turning room lights on and off, or calling a nurse. The entire pillow speaker 10 assembly can be used in an oxygen rich environment and can be cleaned and sterilized because the hermetic seal isolates and protects the electronic components.

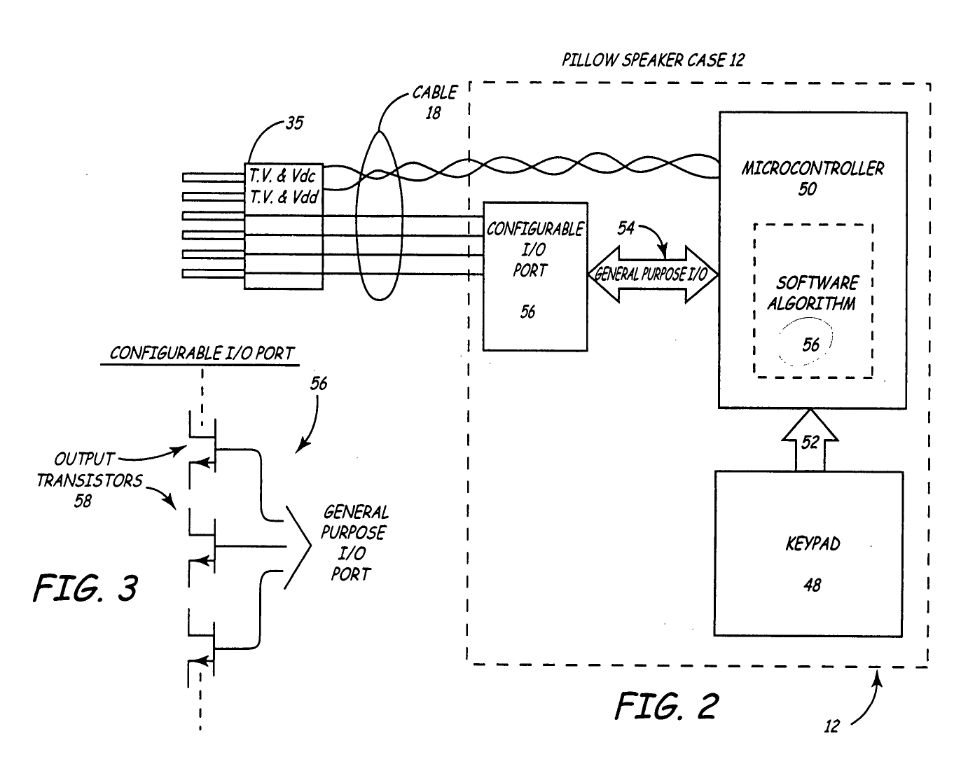

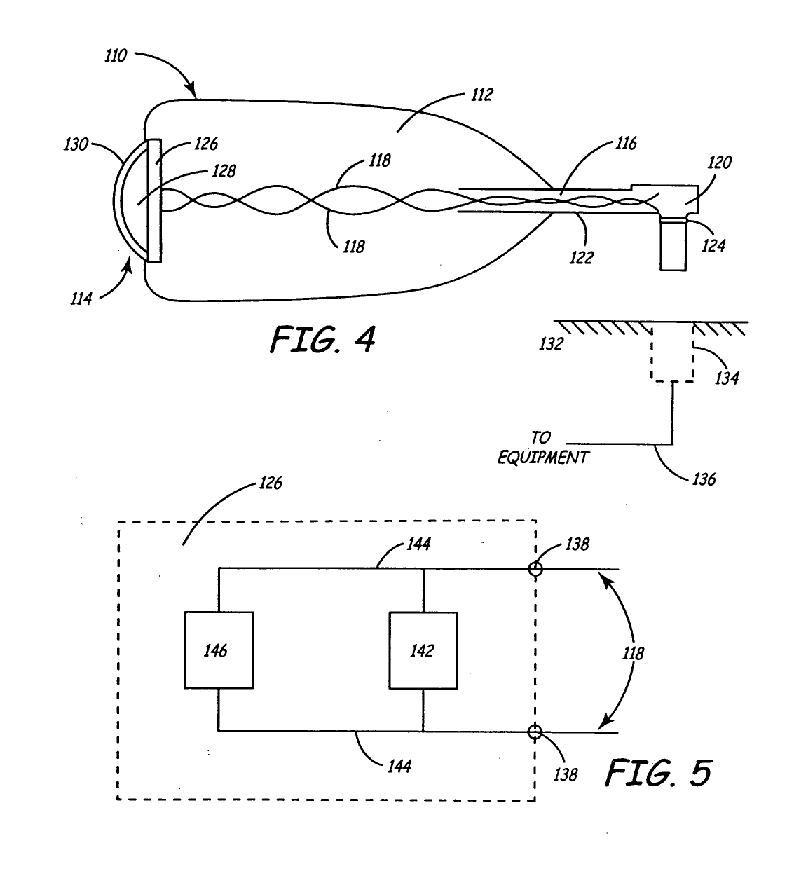

FIG. 2 is a circuit diagram for one embodiment of a membrane switch assembly. FIG. 2 comprises a keypad 48, a microcontroller 50, a data bus 52, a data bus 54, a configurable input/output (“I/O”) port 56, a cable 18, and a first connector 35. The microcontroller 50 in this embodiment is capable of storing and performing the functions contained in an algorithm 56. FIG. 3 is a detailed view of one embodiment of the configurable I/O port 56, which includes a plurality of output transistors 58 capable of sending and/or receiving signals from the cable 18.

In operation, the keyboard 48 generates first electrical signals in response to a user input. The keyboard 48 communicates these signals to the microcontroller 50 using an appropriate circuit in the data bus 52. The microcontroller 50 then decodes the first electrical signals and converts their information into corresponding input/output (“I/O”) control signals. These I/O control signals are then communicated to the appropriate output transistor 58 using the data bus 54. The output transistor 58 uses these signals to generate a second electrical signal in the cable 18. In some embodiments, the second electrical signal may include television control codes.

The power for the circuit 48 in some embodiments may be derived from the devices under the control of the pillow speaker 10. That is, some embodiments do not require that the cable 18 contain a dedicated power line or that the housing 12 contain a battery. These embodiments are desirable because they reduce the stored energy requirement inside the housing 12, thus improving the safety of the design. However, embodiments that use power from other sources are also within the scope of the present invention.

The microcontroller 50 may be any device capable of executing receiving the first electrical signals from the keypad 48, executing the algorithm 56, and sending second electrical signals to a device under control. The microcontroller 50 in some embodiments comprises a non-volatile, programmable control device. Appropriate control devices include, without limitation, erasable programmable read-only memory (EPROM), electronically erasable programmable read-only memory (EEPROM), flash memory, bubble memory, or ferroelectric random access memory (FRAM®). These embodiments are particularly desirable because different brand televisions typically require different control signals. The ability to change or “reprogram” the algorithm 56 may allow manufacturers to use one standard set of hardware to control different televisions and may allow customers to use the same hardware when they purchase new televisions. Despite these advantages, however, volatile and non-reprogrammable microcontrollers 50 are within the scope of this invention.

Although this aspect of the present invention has been described in detail with reference to certain examples thereof, it may be also embodied in other specific forms without departing from the essential spirit or attributes thereof. For example, the cable 18 could be replaced with an infrared, ultrasonic, or radio frequency remote control device similar to those used in televisions and VCRs. This “remote control” could communicate with custom receivers or directly with the electronic devices. The present invention could also be adapted to use standard electrical power wires, rather than a special purpose electrical network, to transmit its electrical signals. These embodiments may be particularly desirable for “home care” patients. In addition, the present invention could use several speakers, one for the television audio and one for communicating with the nurses. These speakers may be located in the same device or may be located in separate devices. The present invention further could be modified to use air powered speakers and devices, similar to those found on airplanes. These embodiments may be desirable because they would not require that any electrical components be located inside the housing 12. Still other embodiments may include a microphone so that the patient may talk to the nurse without disturbing other patients.

II. Second Embodiment

FIG. 5 is a front view of a hermetically sealed nurse call cord embodiment 110. As shown in FIG. 5, this call cord embodiment 110 comprises a tapered tubular housing 112 having a switch 114 mounted axially on one end and a flexible cable 116 emerging from the opposite end. The cable 116 comprises at least one pair of flexible electrical conductors 118 operably connected to a first electrical connector 120. The cable 116 may also include a seal 124 and a flexible molding 122 that covers the electrical conductors 118 and the electrical connector 120. The switch 114 may comprise a printed circuit board 126, a switch dome 128, and a thin flexible membrane 130. FIG. 5 also depicts a wall section 132 that includes a second electrical connector 134 adapted to mate with the first connector 120 and with a network of electrical wires 136. This network 136 may connect the nurse call cord 110 to various equipment and signaling devices (not shown). The entire nurse call device is hermetically sealed so that it can be used in oxygen rich environments and so that it can withstand the sterilization and cleaning methods commonly used by hospitals.

In operation, a nurse will couple the first connector 120 to the second connector 134, then will give the call cord 110 to a patient. When the patient wishes nursing attention, the patient will touch the switch dome 128. This action causes the switch 114 to close an electrical circuit, which allows an electrical signal to travel through the cable 116. The cable 116, in turn, carries this signal from the call cord 110 to the network 136. The network 136 carries the signal to the various other equipment and signaling devices.

The switch 114 may be any device capable of communicating a signal in response to a user input. In some embodiments of the present invention, the switch 114 consists of a switch dome 128 made from an electrically conductive material, such as stainless steel, that is operably connected to a printed circuit board 126. The printed circuit board 126 is, in turn, electrically connected to the cable 116. A user activates the switch 114 in these embodiments by depressing a stainless steel switch dome 128 into the housing 112. This action closes an electrical contact, which completes a circuit and allows an electrical signal to travel through the cable 116 between the switch 114 and the network 136. The switch dome 128 returns to its “rest” position when the user releases it, which opens the electrical contact and prevents electrical signals from traveling through the cable 116. The stainless steel switch 128 dome is desirable because it is wear resistant. However, other switch dome materials are within the scope of this invention. These include, without being limited to, aluminum, zinc, copper, polyester, polyvinyl chloride (“PVC”), and polyethylene. Other styles and types of switches 114, such as a membrane switch assembly that is bonded to the housing 112 by a suitable waterproof adhesive, are also within the scope of the present invention.

The signal from the switch 114 can be used with any device capable of being controlled by a switch closure or by causing a short circuit. In some embodiments, the signal is used as part of a nurse call system. The electrical signal in these embodiments may activate an indicator light that is located outside the patient's room or at a central nursing station. This indicator light alerts the staff that the patient needs attention. The indicator light may also include circuitry that allows it to remain illuminated until specifically turned off, even if the patient does not continuously depress the switch dome 128. In other embodiments, the signal may activate a bell or horn that audibly indicates that the patient needs attention. In still other embodiments, the signal is used to control over-bed lights or used with an infusion pump capable of providing a controlled dosage of pain medication on demand to severely ill patients. Other uses of the switch are also within the scope of the present invention.

The switch 114 may be covered by a suitable water resistant and electrically insulating membrane 130. This membrane is desirable because it helps form a hermetic seal between the user surface and the inside of the switch when plastic is injected during a molding process. The membrane 130 is also desirable because it helps provide electrostatic discharge (“ESD”) isolation between the user and the switch dome 128. These features allow the call cord 110 to be safely used in oxygen rich environments and help it to satisfy Underwriters' Laboratories (“UL”) requirements for hospital signaling and nurse call equipment and for use in hazardous locations. In some embodiments, this membrane 130 is made from polyester. These embodiments are desirable because polyester resists many common chemicals, is electrically insulating, and is relatively inexpensive. However, other materials are within the scope of this invention, including, but not limited to: polyethylene, rubber, latex, and polyvinyl chloride (“PVC”).

The electrical cable 116 in some embodiments may be a “twisted pair” cable a similar to those used to carry telephone signals. The cable 116 carries electrical signals between the connector 120 and the printed circuit board 126. One end of the cable 116 enters the housing 112 and terminates, inside the housing 112, at printed circuit board 26. The other end of the cable 116 is soldered to the first connector 120. The seal 24 may placed between in the opening between the cable 116 and the first connector 120. This seal 124 can be any device capable of preventing liquids or gasses from contacting the electrical components. It is desirable, however, that the seal 124 be resistant to most chemical cleaning and sterilization methods. Appropriate seals 124 include, without being limited to, a rubber O-ring or a silicon sealant. In some embodiments, the entire cable/seal/connector assembly may be further over-molded by a suitable flame proof plastic covering 122, such as acrylonitrile butadiene-styrene (“ABS”) or polyvinyl chloride (“PVC”), or by a suitable thermoplastic rubber.

In some embodiments, the call cord 110 may be manufactured by over-molding a one piece housing 112 around the cable 116, the printed circuit board 126, the switch 114, and the membrane 130. These embodiments are desirable because the over molding process forms a hermetic seal around the electrical components. That is, the housing 112 is formed around the circuitry in such a way that liquids and gasses cannot enter into the interior of the call cord 110 in concentrations sufficient to cause electrical malfunction, fire, or explosion hazards. Over-molding is also desirable because it is a simple and inexpensive manufacturing process. In other embodiments, the printed circuit board 126, the switch 114, and the membrane 130 may be placed into a pre-molded housing and hermetically sealed suitable waterproof adhesive or a potting compound. In these embodiments, the cable 116 may be threaded through the housing 112 and attached to the printed circuit board by an appropriate electrical connector, such as a pin receptacle with a solderless tail manufactured by Mill Max of Oyster Bay, New York, or directly soldered to the board. Some embodiments may also include a second seal 24 (not shown) between the cable 116 and the housing 112. Other manufacturing processes and housing styles are also within the scope of this invention.

The housing 112 may be constructed of any material compatible with the chosen manufacturing process that is relatively impermeable to liquids and gasses. It is desirable that the housing material be relatively lightweight, fire resistant, and corrosion resistant. Examples of appropriate materials include, without being limited to: aluminum, stainless steel, acrylonitrile butadiene-styrene (“ABS”), polytetrafluoroethylene (“PTFE”), flame proof polyvinyl chloride (“PVC”), polystyrene, polyethylene, and polyester.

The portion of the cable 116 located outside the housing may also be over-molded by a flexible, flame proof plastic, such as ABS, polyvinyl chloride (“PVC”), or a thermoplastic rubber. This coating is desirable because it provides the cable 116 with additional protection against entry by liquids and gasses, which allows the resulting plastic/switch and plastic/signal cable to be relatively impervious to entry by water, air, and oxygen. The coating may also provide additional wear resistance. However, cables without this covering are also within the scope of this invention.

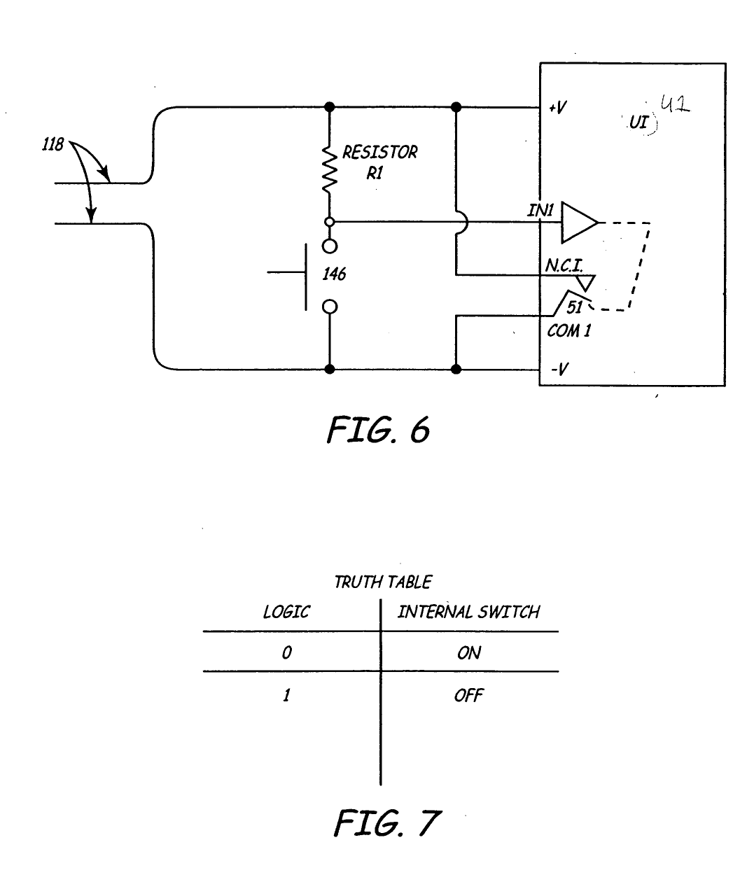

FIG. 6 is a circuit diagram for one embodiment of a membrane switch assembly. FIG. 6 comprises the flexible conductors 118, a pair of connection pads 138, clamping circuit 142, a pair of electrical leads 144, and a switch element 146. In some embodiments, the leads 144 electrically connect the clamping circuit 142 in parallel to the electrical switch 146. The pads 138 in some embodiments electrically connect the leads 144 to the conductors 118.

In operation, the switch element 146 selectively allows a low voltage signal to travel through the flexible conductors 118, the connection pads 138, the leads 144, and the clamping circuitry 142 in response to a user input. That is, the switch element 146 allows electrical signals to travel through the conductors 118 when the switch is closed, but not when the switch is open. The clamping circuitry 142, which may be electrically located in parallel with the switch 146 and physically located on the back side of the circuit board (i.e., the side opposite the switch 146), can shunt current around the switch element 146 to protect against over current conditions.

In some embodiments, the switch element 146 is a normally open electrical contact device that closes when the patient depresses the switch dome 128. These embodiments are desirable because electrical contact devices are relatively simple and inexpensive. However, the switch element 146 may be any device capable of selectively allowing or preventing an electrical signal from traveling through the conductors 118. This specifically includes, without being limited to, a complementary metal oxide semiconductor (“CMOS”) and other similar transistor devices.

The clamping circuitry 142, also known as a shunt circuit in some embodiments, may be a variably conductive device that shunts a portion of the current around the switch 46 when a voltage between the conductors 118 and/or the leads 144 reaches an excessive value. That is, the clamping circuitry 142 has a relatively high electrical resistance when a sufficiently high potential exists between the conductors and a relatively low electrical resistance when a sufficiently low potential exists between the conductors 118. The clamping circuitry 142 is desirable because a voltage differential may develop across some switch 146 embodiments when current flows through them. In some embodiments, the clamping circuitry 142 may be an analog switching device, such as a metal oxide semiconductor field effect transistor (“MOSFET”). However, other devices capable of protecting the patient against over current conditions may also be used. This specifically includes, without being limited to, a diode array, a CMOS transistor or switch, an operational amplifier (“op-amp”), or other variably conductive device electrically located between the conductors 118 and/or the leads 144.

FIG. 7 is a more detailed diagram of one circuit embodiment. FIG. 7 comprises a resistor R1 and a CMOS transistor or switch U1. The CMOS switch U1 includes an IN1 terminal and an internal switch S1, with the internal switch S1 being shown in a logic low position. The resistor R1 and the CMOS switch U1 form the clamping circuitry 142.

When the switch element 146 is open, voltage at the IN1 terminal on U1 is high and the internal switch S1 is open. When the switch element 146 is closed, voltage at the IN1 terminal goes to logic low, and the internal switch S1 closes and shares the current load with the switch element 146. In some embodiments, the CMOS switch U1 is a commercially available device, such as the Siliconix DG642 or the Maxim MAX4543 CMOS switches. However, those skilled in the art will recognize that other circuits and other electronic devices are within the scope of the present invention.

Although this aspect of the present invention has been described in detail with reference to certain examples thereof, it may be also embodied in other specific forms without departing from the essential spirit or attributes thereof. For example, the cable 116 could be replaced with an infrared, ultrasonic, or radio frequency remote control device similar to those used in televisions and VCRs. The present invention could also be adapted to use standard electrical power wires, rather than a special purpose electrical network, to transmit its electrical signals. These embodiments may be particularly desirable for “home care” patients. In addition, the housing in the present invention could be manufactured from a conductive plastic. These embodiments may allow any charge buildup on and in the call cord to drain to the negative polarity conductor 118 or to a third “neutral” conductive wire.

Those skilled in the art will recognize that the accompanying figures and this description depicted and described embodiments of the present invention, and features and components thereof. With regard to means for fastening, mounting, attaching or connecting the components of the present invention to form the mechanism as a whole, unless specifically described otherwise, such means were intended to encompass conventional fasteners such as machine screws, nut and bolt connectors, machine threaded connectors, snap rings, screw clamps, rivets, nuts and bolts, toggles, pins and the like. Components may also be connected by welding, friction fitting, adhesives, or deformation, if appropriate. Electrical connections or position sensing components may be made using appropriate electrical components and connection methods, including conventional components and connectors. Unless specifically otherwise disclosed or taught, materials for making components of the present invention are selected from appropriate materials such as metal, metallic alloys, fibers, plastics and the like, and appropriate manufacturing or production methods including casting, extruding, molding and machining may be used. In addition, any references to front and back, right and left, top and bottom and upper and lower are intended for convenience of description, not to limit the present invention or its components to any one positional or spatial orientation. Therefore, it is desired that the embodiments described herein be considered in all respects as illustrative, not restrictive, and that reference be made to the appended claims for determining the scope of the invention.

1. A pillow speaker, comprising
a portable, hand-held water-sealed housing freely and moveably positionable about a patient's head;
at least one switch located within the housing, the switch being capable of receiving a user input to send a first communication;
a sound generator for positioning proximate the patient's head and sealed within the housing, the sound generator being capable of converting an input into an audible sound; and
a communication cable for sending and receiving the first and second communications.

2. The pillow speaker of claim 1, wherein the pillow speaker has a nurse call button.

3. The pillow speaker of claim 1, wherein the pillow speaker has a volume control for the sound generator.

4. The pillow speaker of claim 51, wherein the housing comprises two sections.

5. The pillow speaker of claim 1, further comprising a control device operably connected to the switch.

6. The pillow speaker of claim 1, wherein the housing is formed to ergonomically fit a user's hand.

7. The pillow speaker of claim 1 wherein the switch is a membrane switch.

8. The pillow speaker of claim 1, wherein the pillow speaker is adapted for use in an oxygen rich environment.

9. The pillow speaker of claim 1, wherein the sound generator is a piezo electric speaker that is hermetically sealed to the housing.

10. A pillow speaker, comprising
a portable, hand-held hermetically sealed housing freely and moveably positionable about a patient's head;
at least one switch located within the housing, the switch being capable of receiving a user input to send a first communication;
a hermetically sealed sound generator for positioning proximate the patient's head and sealed within the housing, the sound generator being capable of converting an input into an audible sound to provide a second communication; and
a communication cable for sending and receiving the first and second communications.

11. The pillow speaker of claim 10, wherein the pillow speaker has a nurse call button.

12. The pillow speaker of claim 10, wherein the pillow speaker has a volume control for the sound generator.

13. The pillow speaker of claim 10, wherein the housing comprises two sections.

14. The pillow speaker of claim 10, further comprising a control device operably connected to the switch.

15. The pillow speaker of claim 10, wherein the housing is formed to ergonomically fit a user's hand.

16. The pillow speaker of claim 10, wherein the switch is a membrane switch.

17. The pillow speaker of claim 10, wherein the pillow speaker is adapted for use in an oxygen rich environment.

18. The pillow speaker of claim 10, wherein the sound generator is a piezo electric speaker that is hermetically sealed to the housing.
